(19) United States
(12) Patent Application Publication
(10) Pub. No.: US 2015/0165606 A1
(43) Pub. Date: Jun. 18, 2015

(54) POWER WRENCH HAVING A HOLDING SYSTEM

(71) Applicant: WAGNER VERMÖGENSVERWALTUNGS-GMBH & CO. KG, Much (DE)

(72) Inventors: Andreas Niemietz, Much (DE); Bernd Thelen, Much (DE)

(73) Assignee: WAGNER VERMÖGENSVERWALTUNGS-GMBH & CO. KG, Much (DE)

(21) Appl. No.: 14/418,515

(22) PCT Filed: Jul. 8, 2013
(86) PCT No.: PCT/EP2013/064365

§ 371 Date: Jan. 30, 2015

(30) Foreign Application Priority Data
Jul. 30, 2012 (DE) 10 2012 213 367.4

(51) Int. Cl. B25B 23/00; B25B 21/00

(52) U.S. Cl. CPC B25B 23/0078; B25B 21/005

(57) ABSTRACT

In a power wrench having a power unit part containing a drive cylinder, an output part, wherein the output part includes an output shaft that is mounted in a housing and rotated at intervals by the drive cylinder, and a support part, which is disposed on the housing and can be placed against an abutment of a screwing site, it is provided that the housing includes a holding system for fixing the power wrench at the screwing site, wherein the holding system includes at least one holding magnet, which cooperates with the screwing site and prevents the power wrench from rotating away from the abutment.

The present invention relates to a power wrench having a drive unit part containing a drive cylinder, an output part, wherein the output part comprises an output shaft that is mounted in a housing and rotated at intervals by the drive cylinder, and a support part, which is disposed on the housing and can be placed against an abutment of a screwing site.

Hydraulic power wrenches, in which an output shaft is rotated at intervals by way of a drive cylinder, are known. The drive cylinder is a hydraulic cylinder, for example. Following a stroke of the hydraulic piston-cylinder unit, there is the tendency for the output shaft to rotate back by a small angular amount. This is due to the fact that the screw structure and/or the power wrench partially relax after every working stroke. So as to prevent such relaxation, it is already known to have a blocking member engage on the output shaft, the blocking key engages in outer toothing of the output shaft and prevents backward rotation. Devices containing retaining pawl systems can interlock after the final torque has been reached and must then be released from the object to be screwed, requiring a lot of time. Renewed start-up of the wrench to the maximally settable torque is necessary and can result in torque inaccuracies. After every stroke, the devices and screw connections are again subjected to the full clamping force. This creates high loads in the system and continual bending loads at the screw connection.

In principle, there is the drawback of a safety risk due to unreliable holding systems. During the work process, the devices can detach from the screw that is to be turned when the hydraulic aggregate stops, which supplies the power wrench with pressure, in the event of a power failure, or in the case of an incomplete stroke length. This represents quite a significant risk for accidents.

Therefore, it is the object of the present invention to create a power wrench that allows uniform tightening of screws without a safety risk.

The power wrench according to the invention is defined by claim 1. In the power wrench according to the invention having a drive unit part containing a drive cylinder, an output part, wherein the output part comprises an output shaft that is mounted in a housing and rotated at intervals by the drive cylinder, and a support part, which is disposed on the housing and can be placed against an abutment of a screwing site, it is provided that the housing comprises a holding system for fixing the power wrench at the screwing site, wherein the holding system comprises at least one holding magnet, which cooperates with the screwing site and prevents the power wrench from rotating away from the abutment.

It is thus provided on the power wrench according to the invention that the housing is secured on the object to be screwed in the vicinity of the screw connection by way of a holding magnet. During the normal screwing operation, the reaction forces are transmitted via the support part to the abutment of the screwing site. Following a stroke of the drive cylinder, there is the tendency for the output shaft to rotate back by a small angular amount since the screw structure and/or the power wrench partially relax after every working stroke. As a result, a torque is exerted by the screw structure on the output part of the power wrench, and thus on the power wrench itself. The holding system according to the invention allows this torque during the return stroke to be absorbed, whereby detachment of the power wrench from the screw is prevented. The holding system according to the invention in particular allows a rotation of the power wrench away from the abutment to be prevented, whereby the support part is seated against the abutment during the entire screwing operation. It is thus prevented that the power wrench has to be placed back against the abutment prior to a working stroke. Compared to a system in which a retaining pawl is used, the holding system according to the invention has the advantage that no mechanical wear is created.

As a result of the holding magnet, the holding system can advantageously be fixed at the screwing site since the object to be screwed is typically made of a ferromagnetic material, and the holding magnet can thus advantageously cooperate with the screwing site. It is also possible, of course, to attach a ferromagnetic part to the screwing site, with which the holding system can cooperate.

The system according to the invention allows a mechanic to simultaneously monitor multiple screwing operations carried out with power wrenches, or to simultaneously monitor multiple power wrenches. The power wrench is reliably positioned and secured in every working position, regardless of the phase of the respective stroke. In addition, no stepped latching engagement takes place. Moreover, the retaining system is continuously active when a permanent magnet is used as the primary magnet. No additional bending moments act on the screw connection either, as is the case in systems containing pawls. No jamming of the screwing tool occurs after the last stroke. Consequently, time-consuming release procedures are eliminated. Secure removal of the device is ensured. As a result of the elimination of a latching engagement and disengagement, the device is secured in any arbitrary working position.

In one exemplary embodiment of the invention, it is provided that the holding system is disposed on the support part of the housing. Such an arrangement has proven to be particularly advantageous since typically sufficient space is available in the surroundings of the abutment, in which the support part is disposed, for the holding system to engage.

The support part can also be composed of a reaction arm. The reaction arm has the advantage that the power wrench can be adapted to the screwing site by way of the reaction arm, so that the support part is advantageously seated against the abutment. In this way, the holding system can likewise cooperate with the screwing site in an advantageous manner. The reaction arm can be designed to be pivotable and/or rotatable. The reaction arm can in particular be pivoted about an axis parallel to the rotational axis of the output shaft of the power wrench, or rotated about an axis orthogonal to the rotational axis of the output shaft, for example by way of a 360° pivot bearing arrangement.

In one exemplary embodiment of the invention, it is provided that the support part comprises a support plate. The support part can advantageously lean against the abutment by way of the support plate.

In a particularly preferred exemplary embodiment, it is provided that the at least one holding magnet is a permanent magnet, and preferably a magnet made of a neodymium iron boron alloy. Such magnets are extremely strong, so that a high holding force can be applied by the holding system. Designing the at least one holding magnet as a permanent magnet has the advantage that the magnetic holding system is thus continuously active. It is not necessary to switch the system on or off. Moreover, the holding system containing a permanent magnet is independent from any energy supply system.

As an alternative, it may be provided that the at least one holding magnet is designed as an electromagnet. This has the advantage that the magnetic action of the holding magnet can be deactivated, so that removal of the power wrench is simplified, for example.

The invention advantageously provides for the at least one holding magnet to have a holding force of at least 70 N. Such a holding force has proven to be particularly advantageous. Depending on the size of the screws, different magnetic strengths can be used.

The at least one holding magnet can be attached in the housing in a spring-loaded manner. It may be provided in particular that the at least one holding magnet is disposed in a seat, wherein a spring preloading force holds the at least one holding magnet in the seat. The spring preloading force can be adjustable, for example. Such a mounting makes it possible to pull the holding magnet partially out of the seat during use, so that differences in height at the screwing site can be compensated for, for example, and thereby secure holding of the holding system at the screwing site is ensured.

The invention will be described in more detail hereafter with reference to the following figures.

In the drawings:

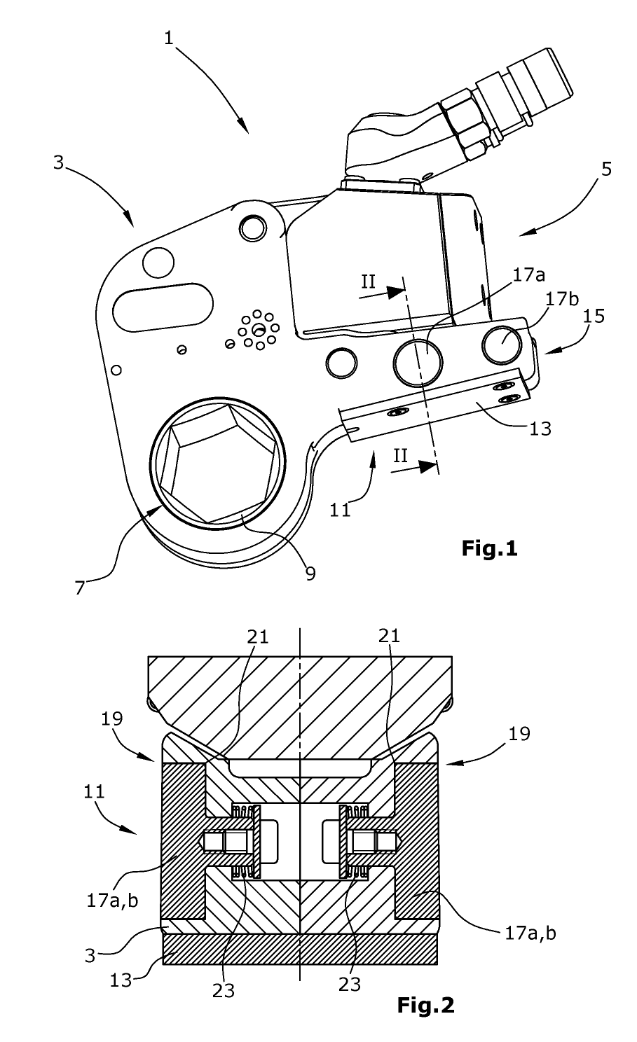

FIG. 1 shows a schematic side view of a power wrench according to the invention;

FIG. 2 shows a sectional view along line I-I of FIG. 1;

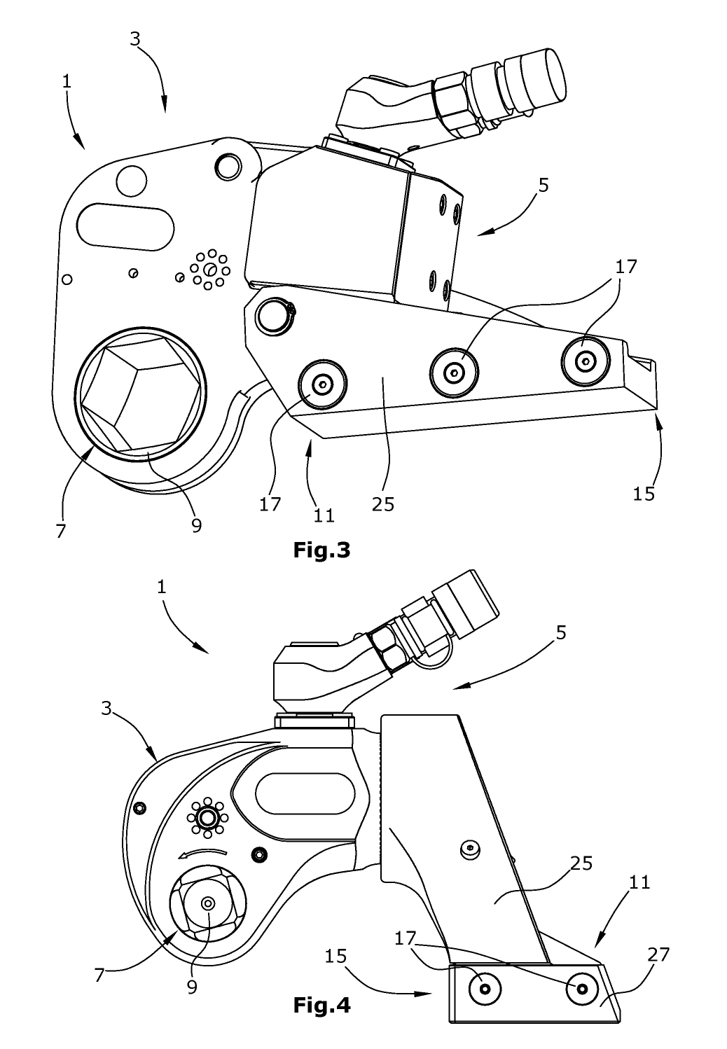

FIG. 3 shows a schematic side view of a second exemplary embodiment of the power wrench according to the invention;

FIG. 4 shows a schematic side view of a third exemplary embodiment of a power wrench according to the invention; and

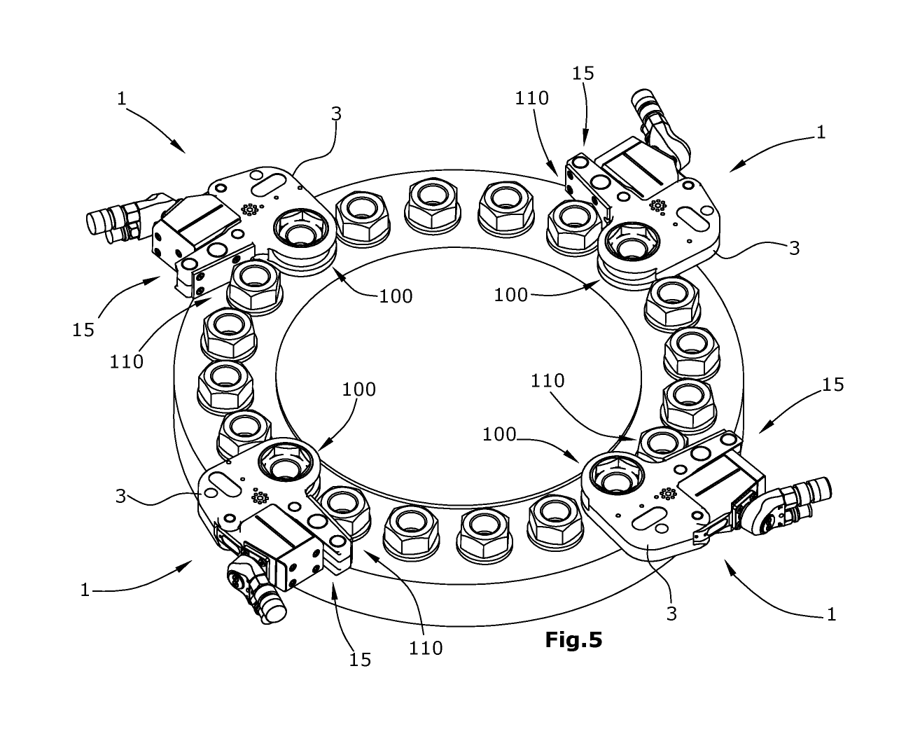

FIG. 5 shows an exemplary illustration of a multi wrench application.

FIG. 1 shows a schematic side view of a power wrench 1 according to the invention. The power wrench comprises a housing 3, which has a substantially L-shaped design and contains a power unit part 5 in one leg. The power unit part 5 includes a drive cylinder (not shown), which can be a hydraulic piston-cylinder unit having a reciprocating piston rod. An output part 7 includes an output shaft 9, which is mounted in the housing 3 and is a hollow shaft here, having a hexagon profile. The output shaft 9 is rotated at intervals by the moving piston rod by way of a gearbox, which is not shown.

In the power wrench 1 according to the invention, the gearbox can comprise a ratchet handle, for example, which is coupled by way of a gear tooth system to outer teeth of the output shaft 9.

The housing 3 further comprises a support part 11, which includes a support plate 13. By way of the support part 11, the housing 3 is able to be supported on the abutment (not shown) of a screwing site in that the support part 11 is seated with the support plate 13 against the abutment. In this way, the reaction forces that develop during a working stroke of the drive cylinder can be supported on the abutment.

The support part 11 furthermore comprises a holding system 15, which includes multiple holding magnets 17a and 17b. The holding magnets 17a and 17b are disposed laterally in the housing, so that they are seated on an object to be screwed when the power wrench 1 is applied. The holding magnets 17a, 17b can thus cooperate with the screwing site, and the power wrench 1 can be prevented from rotating away from the abutment.

Two different holding magnets 17a, 17b are used in the exemplary embodiment shown in FIG. 1. The holding magnet 17a can have a holding force of 40 N, for example, wherein the holding magnet 17b has a holding force of only 30 N.

As is best apparent from FIG. 2, the holding magnets 17a, 17b are mounted in the housing 3 in a spring-loaded manner. The housing 3 has recesses 19 for this purpose in the region of the support part 11, which form a seat 21 for the holding magnets 17a, 17b. The holding magnets are held in the seat 21 via the spring 23 by way of a spring preloading force. The holding magnets 17a, 17b can thus be pulled out of the housing 3 against the spring preloading force, so that the holding system 15 can also be adapted to an uneven surface of a screwing site. In this way, secure seating of the power wrench 1 can be ensured.

FIG. 3 shows a second exemplary embodiment of a power wrench 1 according to the invention. The power wrench shown in FIG. 3 is designed substantially identically to the power wrench 1 according to the invention shown in FIG. 1, with the difference that the support part 11 comprises a reaction arm 25, by way of which the power wrench 1 can be placed against the abutment of the screwing site. The reaction arm 25 allows the power wrench 1 to be advantageously adapted to the screwing site. The reaction arm 25 can be pivoted about an axis extending parallel to the rotational axis of the output shaft 9.

In the exemplary embodiment shown in FIG. 3, the holding system 15 is disposed on the reaction arm 25, so that the holding magnets 17 are attached in the reaction arm 25. In the exemplary embodiment shown in FIG. 3, the holding magnets 17 are rigidly attached, which is to say without spring-loaded mounting.

FIG. 4 shows a third exemplary embodiment of a power wrench 1 according to the invention. As in the second exemplary embodiment shown in FIG. 3, the support part 11 is composed of a reaction arm 27, which comprises a support shoe 27. In the exemplary embodiment shown in FIG. 4, the holding system 15 is disposed in the support shoe 27, so that the holding magnets 17 are attached in the support shoe 27.

The reaction arm 25 of the exemplary embodiment shown in FIG. 4 can be rotated 360° about an axis that extends orthogonally to the rotational axis of the output shaft 9. In this way, particularly flexible adaptation to the abutment is possible.

FIG. 5 schematically shows how multiple power wrenches according to the invention can be used in a multi wrench application. With the aid of the holding system 15 according to the invention, the power wrenches 1 are reliably positioned at the screwing sites 100 and placed against the abutments 110. As a result of the holding system 15 according to the invention, the power wrench 1 is prevented from rotating away from the abutment 110. A mechanic can thus simultaneously monitor multiple screwing operations that are carried out with the power wrenches 1. In the exemplary embodiment shown in FIG. 5, four power wrenches 1 are used simultaneously. The multi wrench application additionally has the advantage that the screwing operation of the object to be screwed can be carried out more uniformity since, as shown in FIG. 5, two pairs of screwing sites 100 disposed opposite of each other can be screwed simultaneously.

The holding magnets 17, 17a, 17b can be permanent magnets made of a neodymium iron boron alloy, for example. The holding magnets that are effective during use, which is to say typically the holding magnets disposed on one side, together provide a holding force of at least 70 N. Such a holding force has proven to be particularly advantageous.

1-9. (canceled)

10. A power wrench having a power unit containing a drive cylinder, an output part, the output part comprising:
an output shaft which is mounted in a housing and rotated at intervals by the drive cylinder, and a support part, which is disposed on the housing and can be placed against an abutment of a screwing site, wherein
the housing further comprises a holding system for fixing the power wrench at the screwing site, wherein the holding system comprises at least one holding magnet, which cooperates with the screwing site and prevents the power wrench from rotating away from the abutment.

11. The power wrench according to claim 10, wherein the holding system is disposed on the support part of the housing.

12. The power wrench according to claim 10, wherein the support part is composed of a reaction arm.

13. A power wrench according to any one of claims 10, wherein the support part comprises a support plate.

14. A power wrench according to any one of claims 10, wherein the at least one holding magnet is made of a neodymium iron boron alloy.

15. A power wrench according to any one of claims 10, wherein the at least one holding magnet is an electromagnet.

16. A power wrench according to any one of claims 10, wherein the at least one holding magnet has a holding force of at least 70 N.

17. A power wrench according to any one of claims 10, wherein the at least one holding magnet is attached in the housing in a spring-loaded manner.

18. The power wrench according to claim 17, wherein the at least one holding magnet is disposed in a seat, wherein a spring preloading force holds the at least one holding magnet in the seat.
